(19) United States
(12) Patent Application Publication
(10) Pub. No.: US 2022/0009582 A1
(43) Pub. Date: Jan. 13, 2022

(54) FOOT-DECK-BASED VEHICLES WITH PIVOT JOINT AND FIRST AND SECOND RELEASE MEMBERS

(71) Applicant: Yvolve Sports Ltd., Dublin 2 (IE)

(72) Inventor: John MCGOWAN, Balbriggan (IE)

(21) Appl. No.: 17/210,194

(22) Filed: Mar. 23, 2021

Related U.S. Application Data
(60) Provisional application No. 63/050,739, filed on Jul. 10, 2020.

(51) Int. Cl. B62K 3/00; B62K 15/00

(52) U.S. Cl. CPC B62K 3/002; B62K 15/006

(57) ABSTRACT

In an aspect, there is provided a foot-deck-based vehicle which includes a foot deck, wheels, a handlebar structure including a handle and a handlebar stem, a joint connecting the handlebar stem and the foot deck, a first release member and a second release member. The joint permits the handlebar structure to move between a use position and a storage position. The first release member is movable between a first locking position and a first unlocking position, and the second release member is movable between a second locking position and a second unlocking position. When the first and second release members are in the first and second unlocking positions, the handlebar structure is movable between the use and storage positions. The first and second release members are movable in first and second directions, which are at at least a selected angle relative to one another.

### CROSS-REFERENCE TO RELATED APPLICATIONS

This application claims priority to and the benefit of U.S. Provisional Patent Application No. 63/050,739 filed Jul. 10, 2020, the contents of which are incorporated herein in their entirety.

### FIELD OF THE DISCLOSURE

The specification relates generally to foot-deck-based vehicles with pivot joints to facilitate storage, and more particularly with release members for pivot joints for foot-deck-based vehicles.

### BACKGROUND OF THE DISCLOSURE

Vehicles, such as foot-deck based vehicles, such as scooters (also known as kick scooters), have become very popular. In many cases, the foot deck on such vehicles has a long fore-aft dimension to accommodate both feet of a rider atop thereof, one behind the other. These foot-deck-based vehicles typically have two or more wheels, with at least one at each end thereof along the fore-aft dimension.

Some foot-deck-based vehicles include handlebar assemblies that can be grasped during operation. The handlebar assemblies may include a handlebar stem that extends upward from the foot deck. In some cases handlebar handles extend substantially laterally from an opposite end of the handlebar stem.

Without providing a folding mechanism for folding the handlebar assembly relative to the foot deck, these vehicles could require relatively large spaces for storage or transport. Further, such foot-deck-based vehicles may be difficult to transport when not being ridden, as they can be unwieldy to carry.

In some cases, these foot-deck-based vehicles are designed to be collapsible to facilitate storage and carrying. Typically, a down tube connecting a foot deck assembly, which includes the foot deck and the rear wheel(s), and a head assembly, which includes a head tube in which the handlebar assembly and front wheel assembly is received, is jointed or is connected to the foot deck assembly via a joint to permit folding of the head assembly relative to the foot deck assembly.

Some handlebar stems require simple actions to release the handlebar stem for pivoting to its folded position. However, this can result in the inadvertent release of the handlebar stem from its use position during riding of the scooter, thereby endangering the rider. Improved structures are desirable that permit the rider to release the handlebar from the use position quickly, but which are nonetheless safe and are unlikely to be inadvertently actuated.

### SUMMARY OF THE DISCLOSURE

According to an aspect, there is provided a foot-deck-based vehicle which includes a foot deck, a plurality of wheels that are rotatable relative to the foot deck, for supporting the foot-deck-based vehicle on a support surface, a handlebar structure, including a handle and a handlebar stem, a joint connecting the handlebar stem and the foot deck, a first release member and a second release member. The joint permits the handlebar structure to move between a use position and a storage position. In the use position the handle is farther away from the foot deck than in the storage position, for gripping by a rider of the foot-deck-based vehicle. The first release member is movable between a first locking position and a first unlocking position, and the second release member is movable between a second locking position and a second unlocking position. When the first release member is in the first unlocking position and the second release member is in the second unlocking position, the handlebar structure is movable between the use position and the storage position. The handlebar structure is prevented from moving out of the use position by at least one of the first and second release members unless the first release member is in the first unlocking position and the second release member is in the second unlocking position. The first release member is movable in a first direction to the first unlocking position, and the second release member is movable in a second direction to the second unlocking position. The second direction is angled by at least approximately 60 degrees relative to the first direction, and in some embodiments is generally perpendicular to the first direction.

According to another aspect, there is provided a foot-deck-based vehicle which includes a foot deck, a plurality of wheels that are rotatable relative to the foot deck, for supporting the foot-deck-based vehicle on a support surface, a handlebar structure, including a handle and a handlebar stem, a joint connecting the handlebar stem and the foot deck, a first release member and a second release member. The joint permits the handlebar structure to move between a use position and a storage position. In the use position the handle is farther away from the foot deck than in the storage position, for gripping by a rider of the foot-deck-based vehicle. The first release member is movable between a first locking position and a first unlocking position, and the second release member is movable between a second locking position and a second unlocking position. When the first release member is in the first unlocking position and the second release member is in the second unlocking position, the handlebar structure is movable between the use position and the storage position. The handlebar structure is prevented from moving out of the use position by at least one of the first and second release members unless the first release member is in the first unlocking position and the second release member is in the second unlocking position. The first release member is on a lower side of the foot deck and the second release member is on an upper side of the foot deck.

According to yet another aspect, there is provided a foot-deck-based vehicle which includes a foot deck, a plurality of wheels that are rotatable relative to the foot deck, for supporting the foot-deck-based vehicle on a support surface, a handlebar structure, including a handle and a handlebar stem, a joint connecting the handlebar stem and the foot deck, a first release member and a second release member. The joint permits the handlebar structure to move between a use position and a storage position. In the use position the handle is farther away from the foot deck than in the storage position, for gripping by a rider of the foot-deck-based vehicle. The first release member is movable between a first locking position and a first unlocking position, and the second release member is movable between a second locking position and a second unlocking position. When the first release member is in the first unlocking position and the second release member is in the second unlocking position, the handlebar structure is movable between the use position and the storage position. The handlebar structure is prevented from moving out of the use position by at least one of the first and second release members unless the first release member is in the first unlocking position and the second release member is in the second unlocking position. The first release member is a slider, and the second release member is a button. The slider is accessible by the fingers of a hand of a user of the foot-deck-based vehicle at the same time that the button is accessible by a thumb of the hand of the user of the foot-deck-based vehicle.

According to yet another aspect, there is provided a foot-deck-based vehicle which includes a foot deck, a plurality of wheels that are rotatable relative to the foot deck, for supporting the foot-deck-based vehicle on a support surface, a handlebar structure, including a handle and a handlebar stem, a joint connecting the handlebar stem and the foot deck, a first release member and a second release member. The joint permits the handlebar structure to move between a use position and a storage position. In the use position the handle is farther away from the foot deck than in the storage position, for gripping by a rider of the foot-deck-based vehicle. The first release member is movable between a first locking position and a first unlocking position, and the second release member is movable between a second locking position and a second unlocking position. When the first release member is in the first unlocking position and the second release member is in the second unlocking position, the handlebar structure is movable between the use position and the storage position. The handlebar structure is prevented from moving out of the use position by at least one of the first and second release members unless the first release member is in the first unlocking position and the second release member is in the second unlocking position. The first release member is movable relative to both the foot deck and the handlebar structure between the first locking position and the first unlocking position, and the second release member is movable relative to both the foot deck and the handlebar structure between the second locking position and the second unlocking position.

### BRIEF DESCRIPTION OF THE DRAWINGS

Embodiments will now be described, by way of example only, with reference to the attached figures, wherein:

FIG. 1 is a perspective view of a foot-deck-based vehicle in accordance with an embodiment of the present disclosure in a use position;

FIG. 2 is a perspective view of the foot-deck-based vehicle shown in FIG. 1 a storage position;

FIG. 3 is a perspective view of a portion of the foot-deck-based vehicle shown in FIG. 1 with an element removed;

FIG. 4A is a perspective view of an upper side of the foot deck of the foot-deck-based vehicle shown in FIG. 1, illustrating a second release member;

FIG. 4B is a perspective view of a lower side of the foot deck of the foot-deck-based vehicle shown in FIG. 1, illustrating a first release member;

FIG. 5 is a perspective view of a portion of the foot-deck-based vehicle shown in FIG. 1 showing the first and second release members in locking positions;

FIG. 6 is a perspective view of a portion of the foot-deck-based vehicle shown in FIG. 1 showing the first release member in an unlocking position;

FIG. 7 is a perspective view of a portion of the foot-deck-based vehicle shown in FIG. 1 showing the first and second release members in unlocking positions;

FIG. 8 is a perspective view of a portion of the foot-deck-based vehicle shown in FIG. 1 showing the first and second release members and biasing members therefor; and

FIG. 9 is a perspective view of a portion of the foot-deck-based vehicle shown in FIG. 1, showing actuation of the first and second release members.

### DETAILED DESCRIPTION

It is to be understood that the terms “couple”, “coupled”, “connect”, “connected” are not limited to direct mating between the described components, but also contemplate the use of intermediate components to achieve the connection or coupling.

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

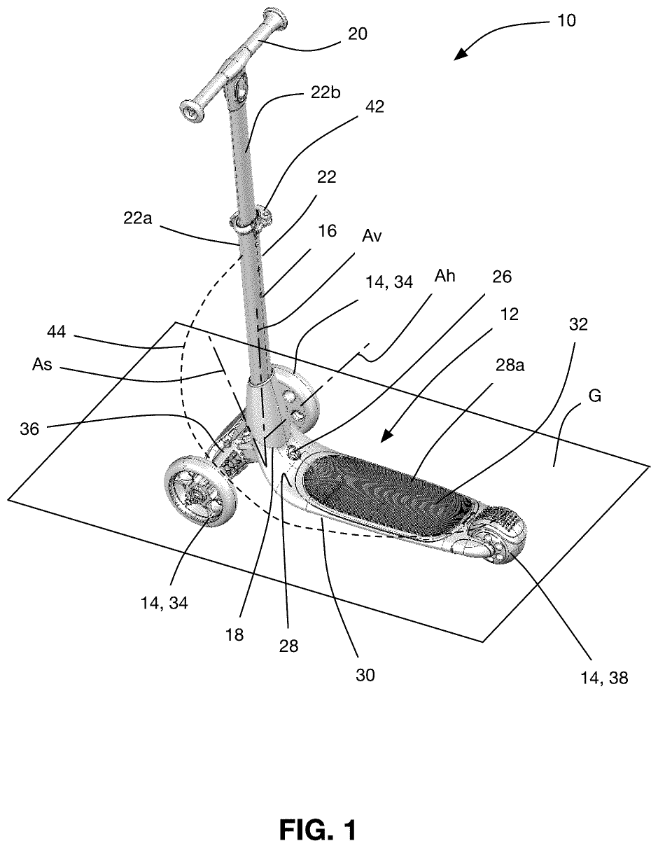

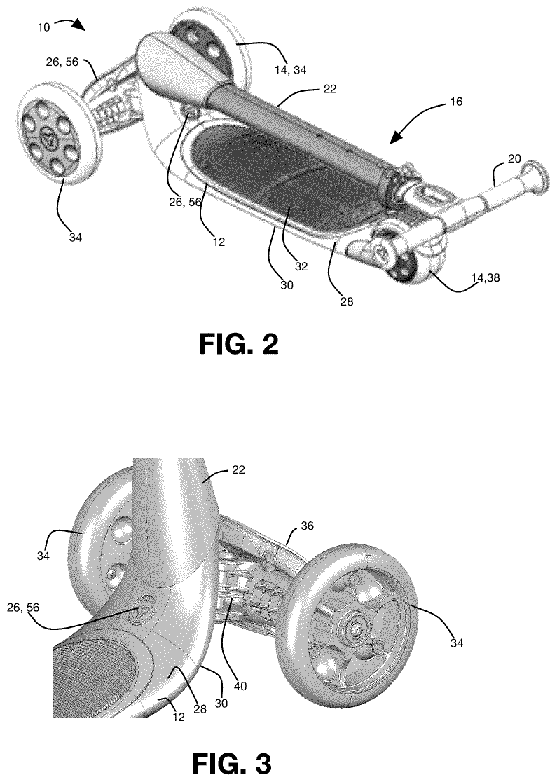

Reference is made to FIGS. 1 and 2 with are perspective views of a foot-deck-based vehicle 10 in accordance with an embodiment of the present disclosure in a use position, and in a storage position, respectively. The foot-deck-based vehicle 10 may be any suitable type of foot-deck-based vehicle and is, in the illustrated examples herein, a scooter. For readability, the term ‘scooter’ will be used herein, but it will be understood that the present disclosure relates to any other suitable foot-deck-based vehicle also.

The scooter 10 includes a foot deck 12 and a plurality of wheels 14 that are rotatable relative to the foot deck 12, for supporting the scooter 10 on a support surface G (e.g. the ground). The scooter 10 further includes a handlebar structure 16 and a joint 18 connecting the handlebar stem 22 and the foot deck 12. The handlebar structure 16 includes a handle 20 and a handlebar stem 22. A first release member 24 and a second release member 26 are provided, for locking and unlocking the handlebar structure 16, as described further below.

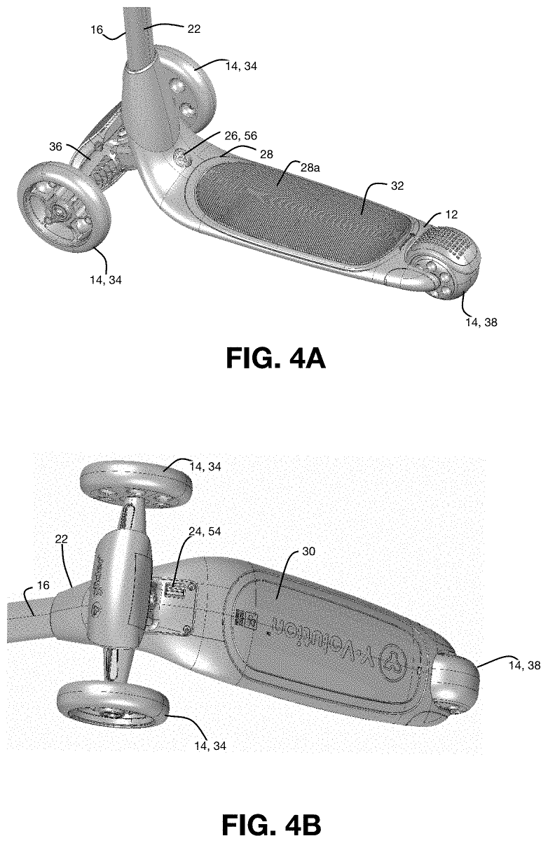

The foot deck 12 has an upper side 28 (a portion of which forms a foot support surface 28a), and a lower side 30 (FIG. 4B). The foot support surface 28a is a surface upon which a rider's feet (not shown) are positioned during use of the scooter 10, and may include a rubber or plastic traction insert 32 or other grip enhancement structure to reduce slippage thereon by the rider's feet.

The plurality of wheels 15 may include a pair of front wheels 34, which are rotatably mounted to a front wheel support member 36, that is itself pivotally mounted to the foot deck 12 for pivoting about a steering axis As, and a rear wheel 38 that is directly rotatably mounted to the foot deck 12. The scooter 10 may be a lean-to-steer type scooter, and as such, the steering axis As may be angled relative to the vertical Av, (e.g. about 45 degrees forward of the vertical axis Av, as shown in FIG. 1, or any other suitable angle), such that the front wheel support member 36 turns in a direction corresponding with a lateral side of the foot deck 12 to which the rider has shifted their weight. A front wheel support member biasing member 40 such as a torsion spring (FIG. 3) is provided to bias the front wheel support member 36 towards a neutral, center position when the front wheel support member 36 is pivoted off of center to either side. A portion of the foot deck 12 that encloses the front wheel support member biasing member 40 is omitted in FIG. 3 so as to illustrate the front wheel support member biasing member 40. Alternatively any suitable structure for providing lean-to-steer capability known in the art may be used. Examples of suitable lean-to-steer structure is described in PCT publication WO2017068078A1, the contents of which are incorporated herein by reference in their entirety.

The handle 20 of the handlebar structure 16 may have any suitable shape. For example, the handle 20 may be a horizontal bar at the top of the handlebar stem 22. The handlebar stem 22 may include a plurality of telescoping sections (e.g. sections 22a and 22b), which are lockable via an over-center clamp 42.

The joint 18 permits the handlebar structure 16 to move between a use position (FIG. 1), thereby putting the scooter 10 in the use position for the scooter 10, and a storage position (FIG. 2), thereby putting the scooter 10 in the storage position for the scooter 10. In the use position, it can be seen that the handle 20 is farther away from the foot deck 12 than in the storage position, so as to be positioned for gripping by a rider of the foot-deck-based vehicle 10.

The joint 18 may be any suitable type of joint, such as a standard pivot joint as seen on typical kick scooters of the prior art, permitting the handlebar stem 22 to pivot about a horizontal axis relative to the foot deck 12. Alternatively, as shown, the joint 18 may be a swivel joint having a swivel axis Ah, such that the handlebar structure 16 is selectively swivelable via the joint 18 along an angled arc (shown by dashed line 44) between the use position and the storage position. The swivel axis As may be angled at any suitable angle relative to the vertical axis Av such as about 45 degrees rearward of the vertical axis Av, or any other suitable angle. In the use position, the handlebar stem 22 may extend generally vertically upwards from the foot deck 12, while in the storage position, the handlebar stem 22 may extend generally horizontally, rearwards from the foot deck 12. The movement of the handlebar stem 22 may be a precessing movement (which is considered for the purposes of the present disclosure to be a type of swiveling movement, which is itself considered to be a type of pivoting movement), between the use and storage positions.

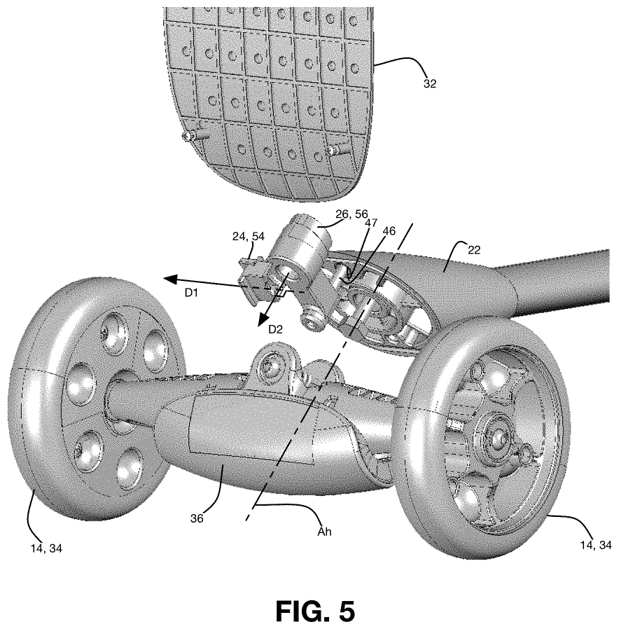

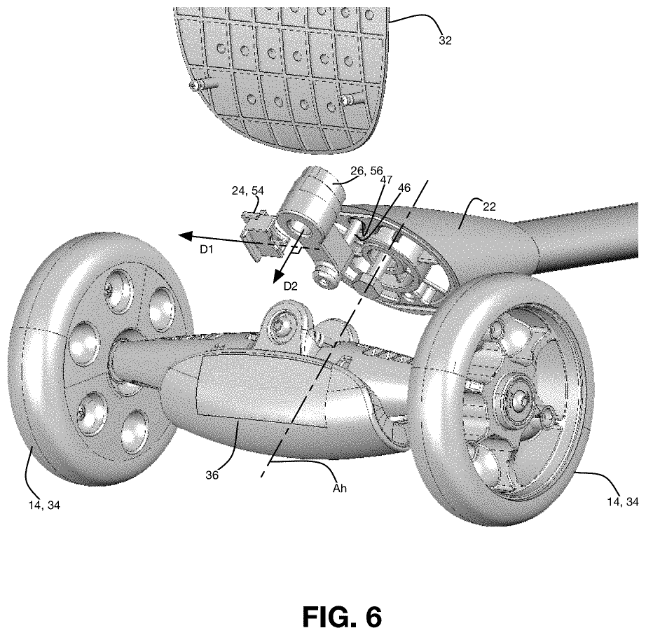

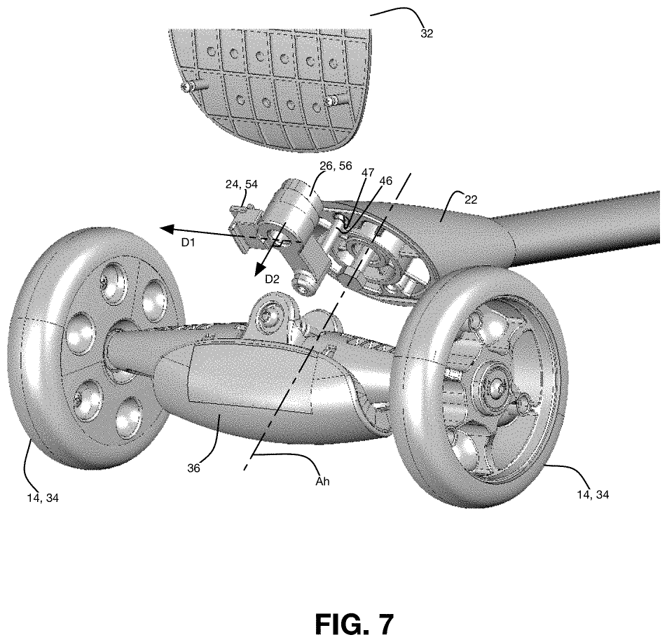

The first release member 24 is movable between a first locking position (FIG. 5) and a first unlocking position (FIGS. 6 and 7). The second release member 26 is movable between a second locking position (FIGS. 5 and 6) and a second unlocking position (FIG. 7). When the first release member 24 is in the first unlocking position and the second release member 26 is in the second unlocking position, as shown in FIG. 7, the handlebar structure 16 is movable between the use position and the storage position. The handlebar structure 16 is prevented from moving out of the use position by at least one of the first and second release members 24 and 26 unless the first release member 24 is in the first unlocking position and the second release member 26 is in the second unlocking position. In the example embodiment shown, the second release member 26 is mounted to the foot deck 12 and includes a pin 46 that is movable into and out of a first locking aperture 47 in the handlebar stem 22. When the second release member 26 is in the second locking position the pin 46 extends into the first locking aperture 47, preventing the handlebar stem 22 from moving out of the use position (FIG. 5). When the second release member 26 is in the second unlocking position, the handlebar stem 22 can move, and therefore the handlebar structure 16 is movable between the use and storage positions. However the second release member 26 is not movable to the second unlocking position until the first release member 24 is moved to the first unlocking position. In other words, as can be seen in FIG. 5, the first release member 24 in the first locking position locks the second release member 26 in the second locking position. More particularly, a first release member shoulder 48 on the first release member 24 blocks the movement of the second release member 26 out of the second locking position. When the first release member 24 is moved to the first unlocking position (FIG. 6), the first release member shoulder 48 is moved out of the way of the second release member 26, thereby permitting the second release member 26 to move to the second unlocking position.

Thus, it will be understood that, unless both the first release member 24 and the second release member 26 are in the first and second unlocking positions, respectively, the handlebar structure 16 is prevented from moving out of the locking position.

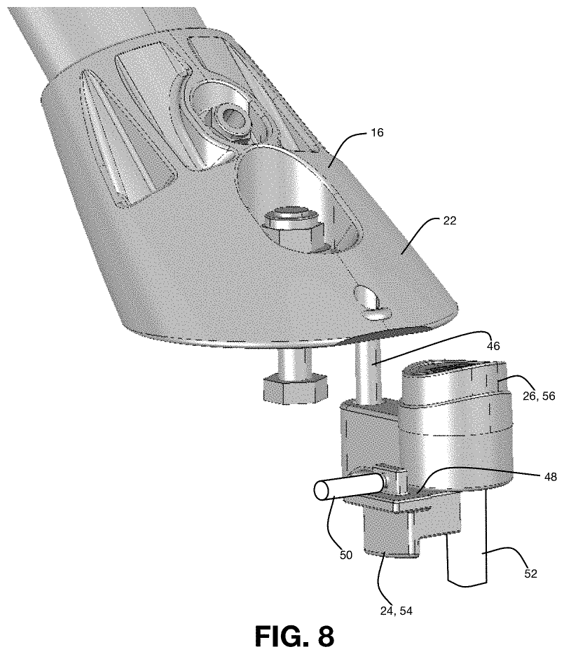

The scooter 10 may further include a first release member biasing member 50 (FIG. 8) and a second release member biasing member 52 (FIG. 8). The first release member biasing member 50 and the second release member biasing member 52 may be any suitable kind of biasing members, such as, for example, two separate helical compression springs, as shown, or alternatively, two portions of a single compression spring that extends along an arced path to engage both the first release member 24 and the second release member 26. The first release member biasing member 50 urges the first release member 24 towards the first locking position, and the second release member biasing member 52 urges the second release member 26 towards the second locking position. The first release member biasing member 50 and the second release member biasing member 52 are represented by cylinders in FIG. 8, but this is done for ease of illustration.

Several aspects of the presence of the first release member 24 and the second release member 26 on the scooter 10 provide added safety to prevent the inadvertent movement of the handlebar structure 16 from the use position.

It will be seen that the first release member 24 is on the lower side 30 (FIG. 4B) of the foot deck 12, and the second release member 26 is on the upper side 28 of the foot deck 12. As a result, it is unlikely that engagement with a single object can cause movement of both the first release member 24 and the second release member 26 to the respective first and second unlocking positions.

Another advantageous feature of the first release member 24 and the second release member 26 is that the first release member 24 is movable in a first direction D1 (FIG. 5) to the first unlocking position, and the second release member 26 is movable in a second direction D2 to the second unlocking position. The first direction D1 may be generally perpendicular to the second direction D2. As a result, a force applied to the scooter in the first direction D1 that might cause movement of the first release member 24, is unlikely to result in movement of the second release member 26, since any vector component of the force that is in the second direction is relatively small. It is theorized that if the second direction D2 is angled by at least approximately 60 degrees relative to the first direction D1, that it is still advantageous, since a force applied in a first direction would have a vector component of not more than approximately 0.5× the force in the second direction, and at least some of that vector component would be neutralized because the force would drive the second release member 26 laterally into whatever sidewall of the aperture the second release member 26 slides in, causing increased friction therewith. Thus, by providing an angle of at least about 60 degrees between the first direction D1 and the second direction D2, less than half of force in the first direction would be applied to the second release member 26.

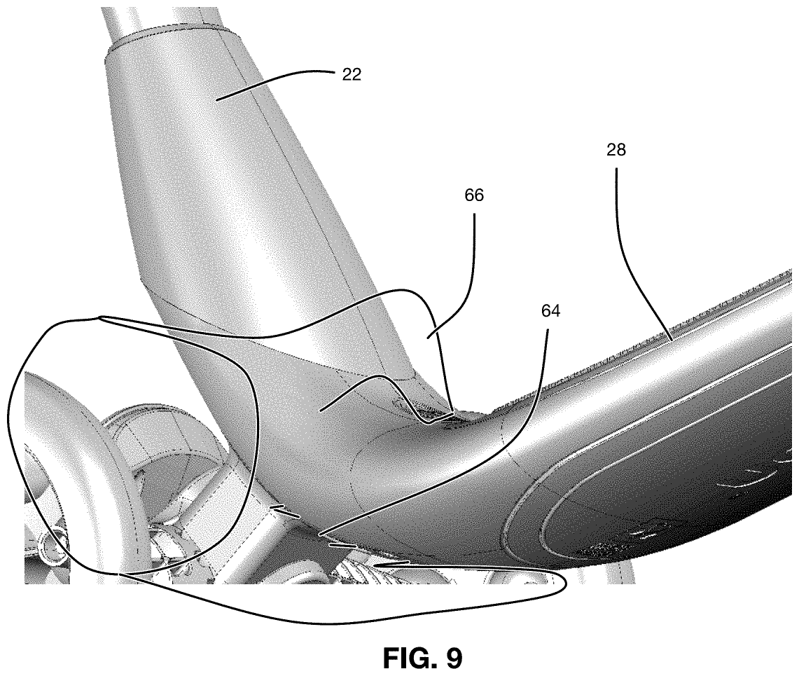

In the example shown, the first direction D1 is generally laterally, and the second direction D2 is generally into the foot deck 12. In the example embodiment shown, the first release member 24 is a slider 54 and the second release member 26 is a button 56. The slider 54 is on the lower side 30 of the foot deck 12, and the button 56 is on the upper side 28 of the foot deck 12. When a user bends down and puts their hand shown at 62 on the foot deck 12 as shown in FIG. 9, the slider is accessible by the fingers 64 of a hand of a rider of the scooter 10 at the same time that the button is accessible by a thumb 66 of the hand of the user of the scooter 10. In a sense the first release member 24 and second release member 26 are actuatable (i.e. movable from the first and second locking positions, respectively, to the first and second unlocking positions, respectively) by a single hand 62 of the rider, thereby freeing up the second hand (not shown) of the rider to focus on moving the handlebar structure 16 from the use position to the storage position.

Another example advantage of the first release member 24 and a second release member 26 is that the first release member is movable relative to both the foot deck and the handlebar structure between the first locking position and the first unlocking position, and the second release member is movable relative to both the foot deck and the handlebar structure between the second locking position and the second unlocking position. The simplifies the structure of the handlebar stem 22 so that it moves purely in a pivoting motion, rather than having to move to an unlocked position and then in a pivoting motion between the use and storage positions.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A foot-deck-based vehicle, comprising:
a foot deck;
a plurality of wheels that are rotatable relative to the foot deck, for supporting the foot-deck-based vehicle on a support surface;
a handlebar structure, including a handle and a handlebar stem;
a joint connecting the handlebar stem and the foot deck, wherein the joint permits the handlebar structure to move between a use position and a storage position, wherein in the use position the handle is farther away from the foot deck than in the storage position, for gripping by a rider of the foot-deck-based vehicle; and
a first release member that is movable between a first locking position and a first unlocking position, and a second release member that is movable between a second locking position and a second unlocking position,
wherein, when the first release member is in the first unlocking position and the second release member is in the second unlocking position, the handlebar structure is movable between the use position and the storage position, and wherein the handlebar structure is prevented from moving out of the use position by at least one of the first and second release members unless the first release member is in the first unlocking position and the second release member is in the second unlocking position,
wherein, the first release member is movable in a first direction to the first unlocking position, and the second release member is movable in a second direction to the second unlocking position, wherein the second direction is angled by at least approximately 60 degrees relative to the first direction.

2. The foot-deck-based vehicle as claimed in claim 1, wherein the joint is a swivel joint having a swivel axis, and the handlebar structure is selectively swivelable via the swivel joint between the use position and the storage position.

3. The foot-deck-based vehicle as claimed in claim 1, wherein the first release member is a slider, and the second release member is a button.

4. The foot-deck-based vehicle as claimed in claim 3, wherein the slider is accessible by the fingers of a hand of a user of the foot-deck-based vehicle at the same time that the button is accessible by a thumb of the hand of the user of the foot-deck-based vehicle.

5. The foot-deck-based vehicle as claimed in claim 1, wherein the first release member in the first locking position locks the second release member in the second locking position.

6. The foot-deck-based vehicle as claimed in claim 1, wherein the first direction is generally perpendicular to the second direction.

7. The foot-deck-based vehicle as claimed in claim 1, wherein the first release member is on a lower side of the foot deck and the second release member is on an upper side of the foot deck.

8. The foot-deck-based vehicle as claimed in claim 1, further comprising a first release member biasing member that urges the first release member towards the first locking position and a second release member biasing member that urges the second release member towards the second locking position.

9. The foot-deck-based vehicle as claimed in claim 1, further comprising a movement shoulder that is moved to a blocking position to hold the first and second release members in the first and second unlocking positions during movement of the handlebar structure between the use position and the storage position, and which is moved to an unblocking position to permit the first and second release members are movable to the first and second locking positions respectively when the handlebar structure is in the use position.

10. A foot-deck-based vehicle, comprising:
a foot deck;
a plurality of wheels that are rotatable relative to the foot deck, for supporting the foot-deck-based vehicle on a support surface;
a handlebar structure, including a handle and a handlebar stem;
a joint connecting the handlebar stem and the foot deck, wherein the joint permits the handlebar structure to move between a use position and a storage position, wherein in the use position the handle is farther away from the foot deck than in the storage position, for gripping by a rider of the foot-deck-based vehicle; and
a first release member that is movable between a first locking position and a first unlocking position, and a second release member that is movable between a second locking position and a second unlocking position,
wherein, when the first release member is in the first unlocking position and the second release member is in the second unlocking position, the handlebar structure is movable between the use position and the storage position, and wherein the handlebar structure is prevented from moving out of the use position by at least one of the first and second release members unless the first release member is in the first unlocking position and the second release member is in the second unlocking position,
wherein the first release member is on a lower side of the foot deck and the second release member is on an upper side of the foot deck.

11. The foot-deck-based vehicle as claimed in claim 10, wherein the first release member is a slider, and the second release member is a button.

12. The foot-deck-based vehicle as claimed in claim 11, wherein the slider is accessible by the fingers of a hand of a user of the foot-deck-based vehicle at the same time that the button is accessible by a thumb of the hand of the user of the foot-deck-based vehicle.

13. The foot-deck-based vehicle as claimed in claim 10, wherein the first release member in the first locking position locks the second release member in the second locking position.

14. The foot-deck-based vehicle as claimed in claim 10, wherein, the first release member is movable in a first direction to the first unlocking position, and the second release member is movable in a second direction to the second unlocking position, wherein the first direction is generally perpendicular to the second direction.

15. The foot-deck-based vehicle as claimed in claim 10, further comprising a first release member biasing member that urges the first release member towards the first locking position and a second release member biasing member that urges the second release member towards the second locking position.

16. The foot-deck-based vehicle as claimed in claim 10, further comprising a movement shoulder that is moved to a blocking position to hold the first and second release members in the first and second unlocking positions during movement of the handlebar structure between the use position and the storage position, and which is moved to an unblocking position to permit the first and second release members are movable to the first and second locking positions respectively when the handlebar structure is in the use position.

17. A foot-deck-based vehicle, comprising:
a foot deck;
a plurality of wheels that are rotatable relative to the foot deck, for supporting the foot-deck-based vehicle on a support surface;
a handlebar structure, including a handle and a handlebar stem;
a joint connecting the handlebar stem and the foot deck, wherein the joint permits the handlebar structure to move between a use position and a storage position, wherein in the use position the handle is farther away from the foot deck than in the storage position, for gripping by a rider of the foot-deck-based vehicle; and
a first release member that is movable between a first locking position and a first unlocking position, and a second release member that is movable between a second locking position and a second unlocking position,
wherein, when the first release member is in the first unlocking position and the second release member is in the second unlocking position, the handlebar structure is movable between the use position and the storage position, and wherein the handlebar structure is prevented from moving out of the use position by at least one of the first and second release members unless the first release member is in the first unlocking position and the second release member is in the second unlocking position,
wherein the first release member is a slider, and the second release member is a button,
wherein the slider is accessible by the fingers of a hand of a user of the foot-deck-based vehicle at the same time that the button is accessible by a thumb of the hand of the user of the foot-deck-based vehicle.
